(19) United States
(12) Patent Application Publication
(10) Pub. No.: US 2018/0083716 A1
(43) Pub. Date: Mar. 22, 2018

(54) PROBABILISTIC SIGNAL SHAPING AND CODES THEREFOR

(71) Applicant: Alcatel-Lucent USA Inc., Murray Hill, NJ (US)

(72) Inventors: Joon Ho Cho, Holmdel, NJ (US); Ronen Dar, Hoboken, NJ (US); Peter J. Winzer, Aberdeen, NJ (US)

(73) Assignee: Alcatel-Lucent USA Inc., Murray Hill, NJ (US)

(21) Appl. No.: 15/374,397

(22) Filed: Dec. 9, 2016

Related U.S. Application Data
(60) Provisional application No. 62/396,644, filed on Sep. 19, 2016.

(51) Int. Cl. H04B 14/00; H04L 1/00; H04B 7/04

(52) U.S. Cl. CPC H04B 14/002; H04B 7/0456; H04L 1/0042

(57) ABSTRACT

We disclose a shaping encoder configured to use a variable-length shaping code to implement fixed-input fixed-output (FIFO) probabilistic signal shaping. In various embodiments, the variable-length shaping code can be a variable-input fixed-output code, a fixed-input variable-output code, or a variable-input variable-output code. The FIFO functionality of the shaping encoder is enabled by a control circuit that operates to: (i) check an output-overflow condition for each bit-word to be encoded using the variable-length shaping code and (ii) switch the shaping encoder from using the variable-length shaping code to using a suitable FIFO code if the output-overflow condition is satisfied. Some embodiments of the shaping encoder can incorporate a conventional FEC encoder in a manner that substantially preserves the shaping gain realized by the shaping encoder.

### CROSS-REFERENCE TO RELATED APPLICATIONS

This application claims priority from U.S. Provisional Patent Application Ser. No. 62/396,644 filed on 19 Sep. 2016, and entitled “PROBABILISTIC SIGNAL SHAPING AND CODES THEREFOR.”

### BACKGROUND

### Field

The present disclosure relates to communication equipment and, more specifically but not exclusively, to methods and apparatus for (i) transmitting information using probabilistic signal shaping and (ii) generating codes therefor.

### Description of the Related Art

This section introduces aspects that may help facilitate a better understanding of the disclosure. Accordingly, the statements of this section are to be read in this light and are not to be understood as admissions about what is in the prior art or what is not in the prior art.

Signal shaping can beneficially provide energy savings often referred to as the shaping gain. In a representative implementation of signal shaping, constellation symbols of a relatively large energy are transmitted less frequently than constellation symbols of a relatively small energy. For example, when constellation symbols are transmitted over a linear communication channel with a rate of occurrence that approximates a continuous Gaussian distribution in every dimension of the operative constellation, the shaping gain can theoretically approach 1.53 dB.

### SUMMARY OF SOME SPECIFIC EMBODIMENTS

Disclosed herein are various embodiments of a shaping encoder configured to use a variable-length shaping code to implement fixed-input fixed-output (FIFO) probabilistic signal shaping. In various embodiments, the variable-length shaping code can be a variable-input fixed-output (VIFO) code, a fixed-input variable-output (FIVO) code, or a variable-input variable-output (VIVO) code. The FIFO functionality of the shaping encoder is enabled by a control circuit that operates to: (i) check an output-overflow condition for each bit-word to be encoded using the variable-length shaping code and (ii) switch the shaping encoder from using the variable-length shaping code to using a suitable FIFO code if the output-overflow condition is satisfied.

Some embodiments of the shaping encoder can incorporate a conventional FEC encoder in a manner that substantially preserves the shaping gain realized by the shaping encoder.

In some embodiments, the variable-length shaping code can be constructed and optimized, using the disclosed methods, to maximize the shaping gain.

Some embodiments beneficially lend themselves to being implemented using digital circuits of relatively small size and/or relatively low complexity.

According to an example embodiment, provided is an apparatus comprising: a shaping encoder configured to use a variable-length shaping code to convert an input block of bits into an output sequence of constellation symbols, the input block of bits having a first fixed number of bits, and the output sequence of constellation symbols having a second fixed number of constellation symbols; and a transmitter operatively coupled to the shaping encoder to transmit a modulated signal carrying the output sequence of constellation symbols.

According to another example embodiment, provided is a machine-implemented communication method comprising the steps of: receiving an input block of bits having a first fixed number of bits; and converting the input block of bits into an output sequence of constellation symbols having a second fixed number of constellation symbols, said converting being performed using a shaping encoder configured to use a variable-length shaping code.

According to yet another example embodiment, provided is a communication method comprising the steps of: configuring a shaping encoder to use a variable-length shaping code to convert an input block of bits into an output sequence of constellation symbols, the input block of bits having a first fixed number of bits, and the output sequence of constellation symbols having a second fixed number of constellation symbols; and operatively coupling a transmitter to the shaping encoder, the transmitter being capable of transmitting a modulated signal carrying the output sequence of constellation symbols.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of a communication system according to an embodiment;

FIGS. 2A-2C graphically show example constellations that can be used in the communication system of FIG. 1 according to some embodiments;

FIGS. 3A-3C show example codebooks representing signal-shaping codes that can be used in the communication system of FIG. 1 according to some embodiments;

FIG. 4 shows an example codebook representing a FIFO code that can be used in the communication system of FIG. 1 according to an embodiment;

FIG. 5 shows a flowchart of an encoding method that can be used in the communication system of FIG. 1 according to an embodiment;

FIG. 6 shows a flowchart of a decoding method that can be used in the communication system of FIG. 1 according to an embodiment;

FIG. 7 shows a block diagram of a communication system according to an alternative embodiment;

FIG. 8 shows some characteristics of an example codebook according to an embodiment;

FIG. 9 shows a binary tree that represents an example codebook according to an embodiment;

FIGS. 10A-10D show example sets of trees that can be used to construct a codebook according to an embodiment;

FIG. 11 shows the set of trees of FIG. 10D with added annotations according to an embodiment;

FIG. 12 shows a table that illustrates the reduction of the search space that can be achieved according to an embodiment; and

FIG. 13 shows several example sets of codewords that have been constructed according to an embodiment.

### DETAILED DESCRIPTION

Modern forward-error-correction (FEC) codes, such as low-density parity-check (LDPC) codes, already approach the constrained Shannon limit to within approximately 0.5 dB. Hence, further investment in the development of better and/or more-sophisticated FEC codes can only provide diminished returns that are limited by this relatively low incremental value of the FEC-coding gain. For comparison, a practically attainable value of the shaping gain can be approximately 1 dB for linear channels, and even higher for nonlinear channels. Due to the latter value being higher than the still-possible increase of the FEC-coding gain (i.e., 1 dB>0.5 dB), development of methods and apparatus for signal shaping is currently being pursued by the telecom industry. Signal-shaping methods that can be implemented with relatively low complexity and/or cost of the corresponding electronic circuits appear to be especially desirable.

There are two general types of signal shaping that are referred to as geometric and probabilistic, respectively. Geometric shaping can be implemented to optimize the location of constellation points (symbols) on the complex plane for a fixed (but not necessarily uniform) symbol probability. Probabilistic shaping can be implemented to optimize the probability of constellation symbols that are located on a fixed (but not necessarily uniform) grid on the complex plane. Although both types of signal shaping can theoretically be implemented to achieve the shaping gain of up to 1.53 dB for an additive-white-Gaussian-noise (AWGN) channel, probabilistic shaping offers several important advantages over geometric shaping. These advantages include but are not limited to compatibility with conventional (e.g., available off-the-shelf) constellations and FEC codes.

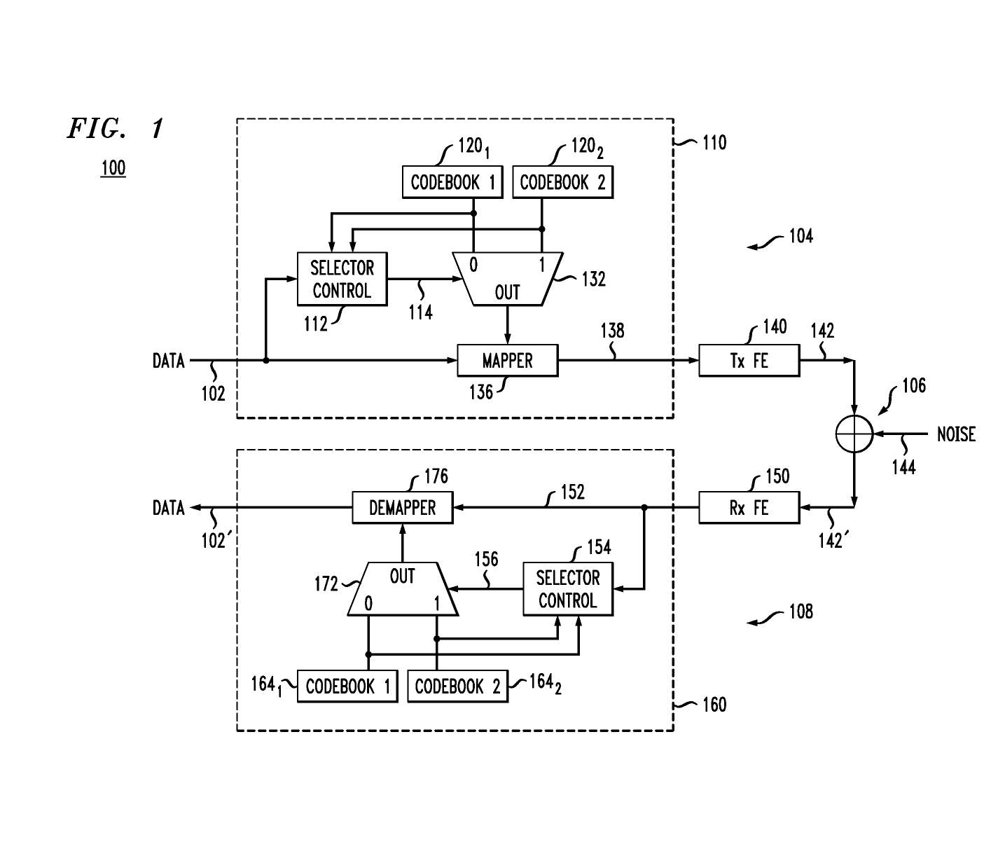

FIG. 1 shows a block diagram of a communication system 100 according to an embodiment. System 100 comprises a transmitter 104 and a receiver 108 that are coupled to one another by way of a communication link 106. In various embodiments, communication link 106 can be an optical link, a wireless link, or a wire-line link.

System 100 implements probabilistic signal shaping using a shaping encoder 110 at transmitter 104 and a shaping decoder 160 at receiver 108. Shaping encoder 110 operates to transform an input data stream 102 into a corresponding sequence 138 of constellation symbols in which different constellation symbols appear with different respective rates of occurrence. A front-end (FE) module 140 of transmitter 104 then uses sequence 138 to generate a corresponding modulated communication signal 142 suitable for transmission over link 106 and having encoded thereon the constellation symbols of sequence 138.

Link 106 imparts a noise 144 and possibly other linear and/or nonlinear signal impairments (not explicitly shown in FIG. 1) onto communication signal 142 and delivers a resulting impaired (e.g., noisier) communication signal 142′ to an FE module 150 of receiver 108. FE module 150 operates to convert the received communication signal 142′ into a corresponding sequence 152 of constellation symbols. Shaping decoder 160 then converts sequence 152 into an output data stream 102′. Provided that the described signal processing in system 100 produces no errors, output data stream 102′ is the same as input data stream 102.

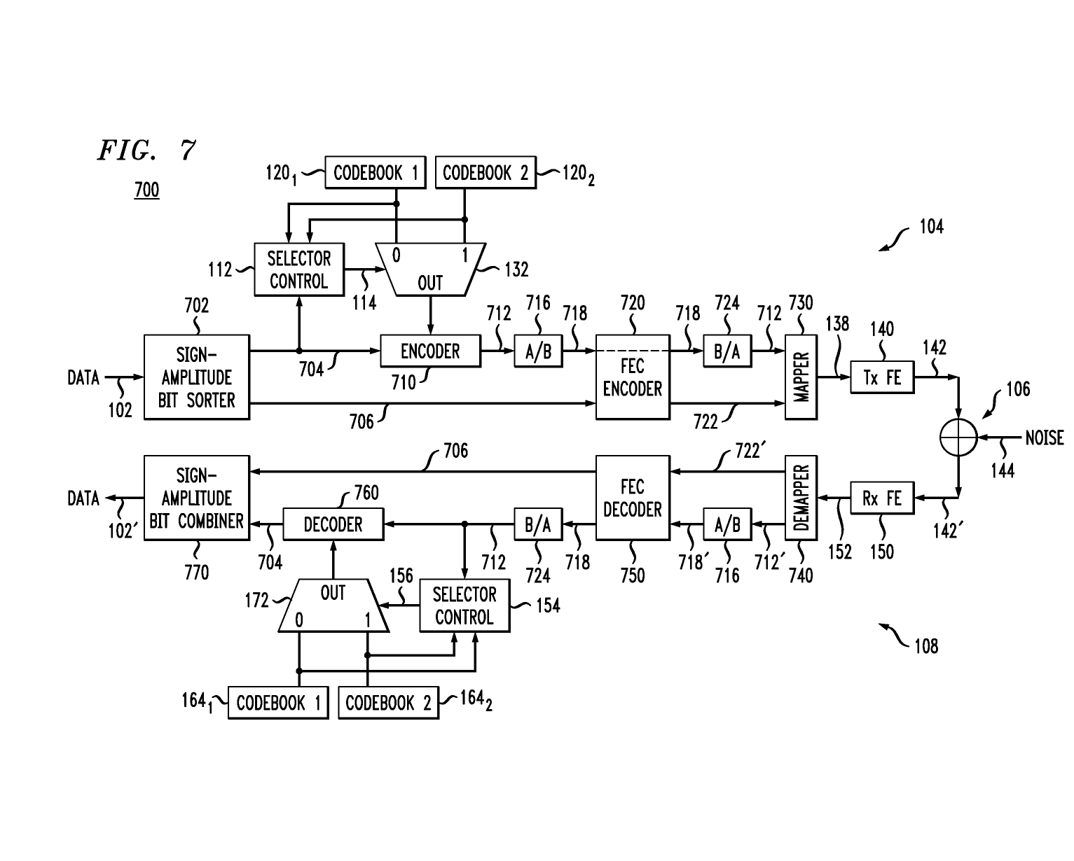

If noise 144 and/or other signal impairments imparted onto the received communication signal 142′ by link 106 are relatively strong, then additional measures can be taken to cause output data stream 102′ to have an acceptably low bit-error rate (BER). An example of such measures is described in more detail below in reference to FIG. 7. Implementation details of FE modules 140 and 150 depend on the type of link 106 and are known to those skilled in the pertinent art. For example, when link 106 is an optical link established over an optical fiber or fiber-optic cable, FE module 140 can be implemented using a conventional optical IQ modulator (not explicitly shown in FIG. 1), whereas FE module 150 can be implemented using a conventional coherent (e.g., intradyne or homodyne) optical receiver (also not explicitly shown in FIG. 1).

Shaping encoder 110 comprises a constellation mapper 136 that operates to (i) parse input data stream 102 into bit-words using the codebooks stored in look-up tables (LUTs) 120₁ and 120₂, (ii) convert each of the bit-words into a corresponding codeword using the codebooks stored in LUTs 120₁ and 120₂, and (iii) further convert each of the codewords into a corresponding constellation symbol or set of constellation symbols, thereby generating constellation-symbol sequence 138.

As used herein, the term “constellation symbol” should be construed to encompass both constellation symbols of a one-dimensional constellation and of a multi-dimensional constellation. An example one-dimensional constellation enables the transmission of a single constellation symbol in a single signaling interval (time slot) over a single dimension of the carrier. In contrast, a multi-dimensional constellation enables the transmission of a single constellation symbol using multiple signaling intervals and/or multiple dimensions of the carrier. For a one-dimensional carrier, the dimensionality of the multi-dimensional constellation can be defined as the number of signaling intervals used for the transmission of a single constellation symbol. An N-dimensional constellation can be constructed using N different one-dimensional constellations or N copies of the same one-dimensional constellation.

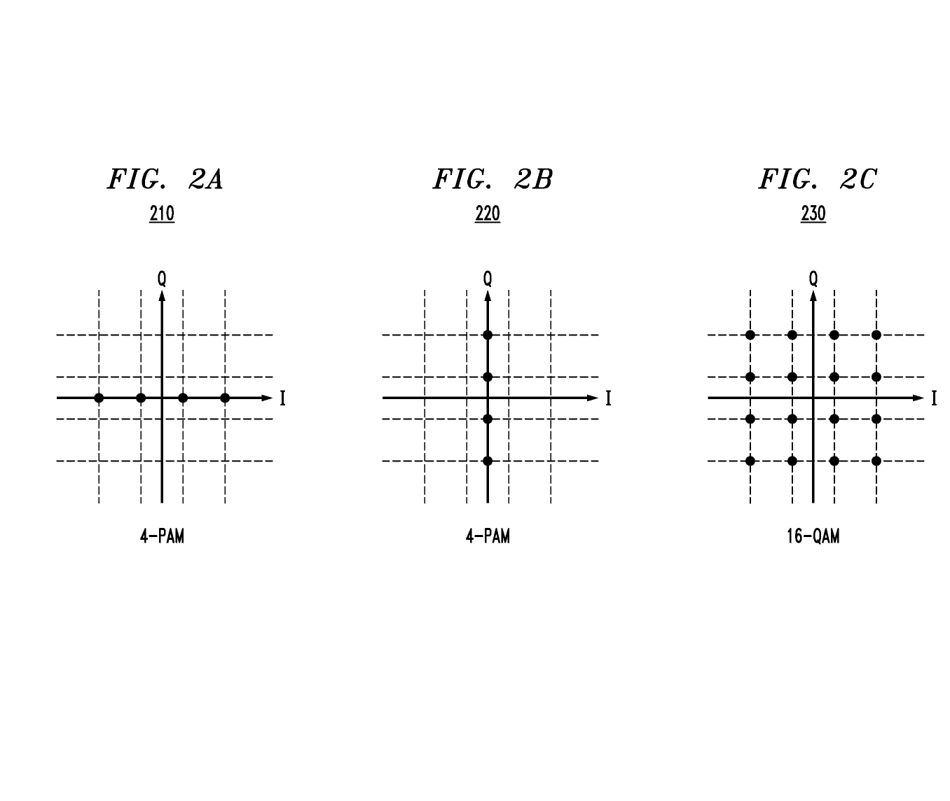

FIGS. 2A-2C graphically show several constellations that can be used to implement constellation mapper 136 according to several example embodiments. Each of the shown constellations is a one-dimensional constellation that is depicted as a set of constituent constellation points on a complex plane whose axes are labeled as the I (in-phase) axis and the Q (quadrature) axis.

FIG. 2A graphically shows a 4-PAM (pulse-amplitude-modulation) constellation 210. The four constellation points of constellation 210 are all located on the I-axis and can be represented by the real numbers −3, −1, +1, and +3. Each of the constellation points can be used to encode two bits. In an example bit assignment, the first of the two bits (e.g., the most-significant bit, MSB) can represent the sign of the corresponding real number, and the second of the two bits (e.g., the least-significant bit, LSB) can represent the absolute value (e.g., the amplitude) of the corresponding real number. In this bit assignment scheme, the two bits assigned to a constellation point can be referred to as the sign bit and the amplitude bit, respectively.

FIG. 2B graphically shows a 4-PAM constellation 220. The four constellation points of constellation 220 are all located on the Q-axis and can be represented by the imaginary numbers −3j, −j, +j, and +3j. Each of the constellation points can be used to encode two bits in a manner similar to that of constellation 210 (FIG. 2A).

FIG. 2C graphically shows a 16-QAM (quadrature-amplitude-modulation) constellation 230. A person of ordinary skill in the art will understand that constellation 230 can be generated using a combination of constellations 210 and 220. For example, constellation 230 can be conceptually viewed as constellation 210 (FIG. 2A) in which each constellation point is split into four using constellation 220 (FIG. 2B). Using the latter concept, an IQ modulator of FE module 140 can be configured to generate communication signal 142 that carries constellation symbols (points) of constellation 230 by (i) generating the I component of signal 142 using constellation 210, (ii) generating the Q component of signal 142 using constellation 220, and (iii) appropriately combining the I and Q components.

A person of ordinary skill in the art will understand that other constellations that differ from the example constellations of FIGS. 2A-2C can also be used to implement constellation mapper 136. For example, an m-PAM constellation (where m is an even integer greater than four) can be constructed by expanding constellation 210, e.g., by placing additional equally spaced constellation points on the I axis (see FIG. 2A). An n-PAM constellation (where n is an even integer greater than four) can similarly be constructed by expanding constellation 220, e.g., by placing additional equally spaced constellation points on the Q axis (see FIG. 2B). An IQ modulator of FE module 140 can then be configured to generate communication signal 142 that carries constellation symbols of an (n×m)-QAM constellation by (i) generating the I component of signal 142 using the m-PAM constellation, (ii) generating the Q component of signal 142 using the n-PAM constellation, and (iii) appropriately combining the I and Q components.

For illustration purposes and without any implied limitation, system 100 is described herein below in reference to an example embodiment in which constellation mapper 136 is implemented using a 4-PAM constellation, such as constellation 210 (FIG. 2A) or 220 (FIG. 2B). Based on the provided description, a person of ordinary skill in the art will be able to make and use, without any undue experimentation, alternative embodiments of system 100 in which constellation mapper 136 is implemented using a PAM or a QAM constellation of a desired size, e.g., constructed in the above-described manner. For an M-PAM constellation, in which M>4, the bits assigned to a constellation point include one sign bit and two or more amplitude bits. For an M-QAM constellation, in which M>4, the bits assigned to a constellation point include two sign bits and three or more amplitude bits.

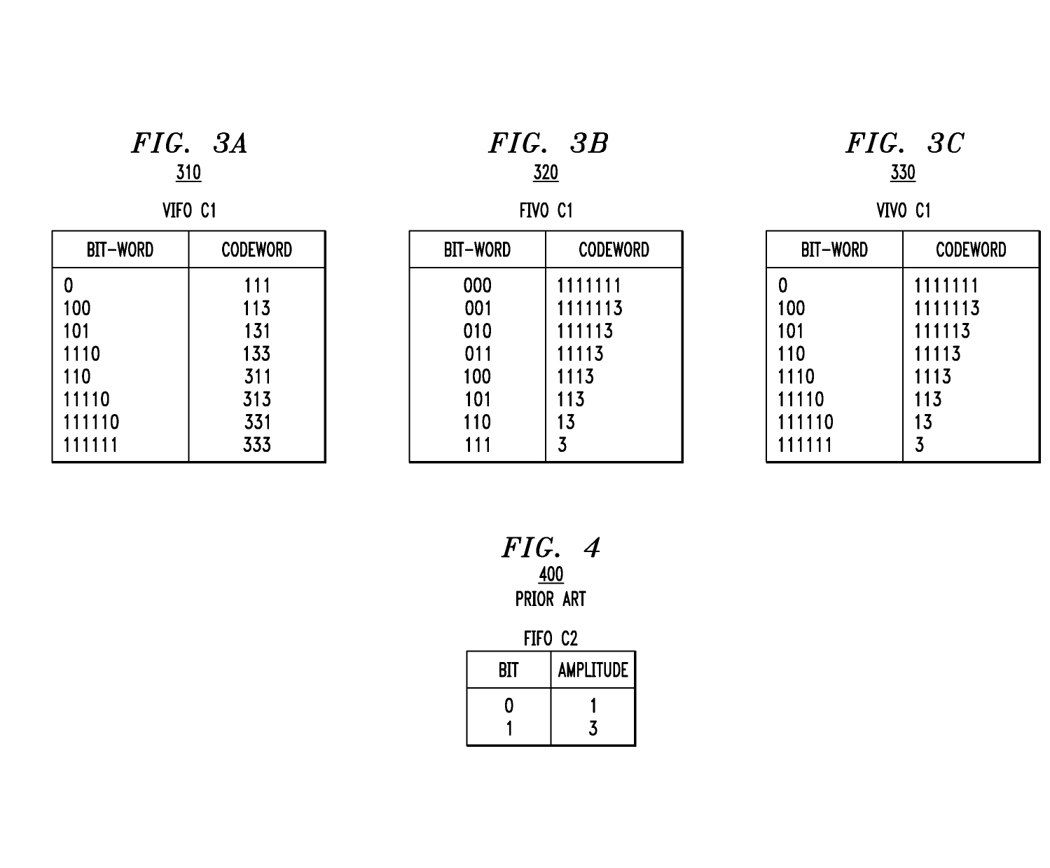

Referring back to FIG. 1, LUT 120₁ stores therein a first codebook (hereafter C1) containing a variable-length signal-shaping code. In various embodiments, codebook C1 can contain a variable-input fixed-output (VIFO) signal-shaping code, a fixed-input variable-output (FIVO) signal-shaping code, or a variable-input variable-output (VIVO) signal-shaping code. Examples of each of these signal-shaping codes are described in more detail below in reference to FIGS. 3A-3C. LUT 120₂ stores therein a second codebook (hereafter C2) containing a fixed-input fixed-output (FIFO) code. An example of the latter code is described in more detail below in reference to FIG. 4.

A codebook selector 132 operates to connect constellation mapper 136 to either LUT 120₁ or LUT 120₂. The state of codebook selector 132 is controlled by a control signal 114 that is generated by a control circuit 112. In an example embodiment, codebook selector 132 connects constellation mapper 136 to LUT 120₁ to enable the constellation mapper to read from codebook C1 if control circuit 112 is de-asserted (e.g., is “low”). Codebook selector 132 connects constellation mapper 136 to LUT 120₂ to enable the constellation mapper to read from codebook C2 if control circuit 112 is asserted (e.g., is “high”). Control circuit 112 changes the state (asserts or de-asserts) control signal 114 based on the analysis of input data stream 102 as further described below, e.g., in reference to Eqs. (1)-(4).

Shaping encoder 110 operates as a FIFO encoder despite the fact that it uses a variable-length signal-shaping code of codebook C1. More specifically, shaping encoder 110 operates on a block of input bits of a predetermined fixed length K to transform it into a corresponding set of constellation symbols of a predetermined fixed length L₂, where K and L₂ are positive integers. The numbers K and L₂ are fixed for each particular embodiment, but can change from embodiment to embodiment. In other words, the numbers K and L₂ are parameters of the signal-shaping algorithm used in system 100.

The FIFO functionality of shaping encoder 110 is enabled by the data processing performed in control circuit 112. More specifically, a variable-length signal-shaping code, such as that of codebook C1, naturally produces a variable-length output from a fixed-length input. The length of the output depends on the input bit sequence and fluctuates around an average length L₀, which is a characteristic of the code. The length L₂ is selected such that L₂>L₀, but is not too large in the sense that some input bit sequences of the length K can still cause the length L of the corresponding C1-coded output to be greater than the length L₂. This condition is hereafter referred to as the “output overflow.” The data processing performed in control circuit 112 is designed to predict a possible output overflow for each particular block of input bits that is being encoded by shaping encoder 110 and switch constellation mapper 136 from the use of variable-length (VIFO, FIVO, or VIVO) signal-shaping code of codebook C1 to the use of the FIFO signal-shaping code of codebook C2 at an appropriate point within the input block such that the output overflow can be avoided.

On the other hand, for some blocks of input bits, the length L of the corresponding C1-coded output can be smaller than the length L₂. This condition is hereafter referred to as the “output underflow.” In this situation, control circuit 112 does not switch constellation mapper 136 from the use of codebook C1 to the use of codebook C2. Instead, constellation mapper 136 appends (L₂-L) constellation symbols, each having fixed arbitrary amplitude, after the encoding of the input block is completed. A person of ordinary skill in the art will understand that the amplitude bits representing the fixed arbitrary amplitude of the appended constellation symbols do not carry any useful information.

Shaping encoder 110 can generate L₂ output constellation symbols for any block of K input bits by (i) switching constellation mapper 136 from the use of the variable-length (VIFO, FIVO, or VIVO) signal-shaping code of codebook C1 to the use of the FIFO code of codebook C2 in case of a predicted output overflow and (ii) appending constellation symbols of arbitrary fixed amplitude in case of the output underflow. A method of generating a suitable codebook C1 that enables system 100 to optimize the shaping gain (e.g., realize a maximum, practically achievable shaping gain) is described in more detail below in reference to FIGS. 8-13.

The following non-limiting examples, which are described below in reference to FIGS. 3-5, further illustrate the FIFO functionality of shaping encoder 110. These examples correspond to an embodiment in which constellation mapper 136 is configured to use of a 4-PAM constellation, e.g., constellation 210 (FIG. 2A). Each constellation point of this 4-PAM constellation is assigned a two-bit value, e.g., as described above in reference to FIG. 2A. In operation, constellation mapper 136 sorts the bits of an input block received via input data stream 102 into two groups. The first group has L₂ bits that are treated as sign bits. The second group has L₁ (=K−L₂) bits that are treated as amplitude bits. The sign bits are not encoded. The amplitude bits are encoded using codebooks C1 and C2. If necessary, a set of fixed amplitudes is appended to the encoded amplitudes to generate a total of L₂ amplitudes. The L₂ sign bits are then combined with the L₂ amplitudes to generate L₂ 4-PAM constellation symbols for sequence 138.

FIGS. 3A-3C show three examples of codebook C1 that can be used in system 100 according to some embodiments.

FIG. 3A shows a C1 codebook 310 that represents an example VIFO signal-shaping code. Assuming that binary zeros and ones are equiprobable in the input data stream 102, codebook 310 causes the corresponding 4-PAM amplitudes “1” and “3” to have the following respective probabilities, Pr, in sequence 138:

Pr[1]=0.79;

Pr[3]=0.21.

The average transmit energy per constellation symbol for codebook 310 is 2.71. The average number of amplitudes per information bit is 1.35.

Note that each of the codewords of C1 codebook 310 has three amplitudes and, as such, can be transmitted using three signaling intervals. As a result, in some embodiments, C1 codebook 310 can be used in conjunction with an appropriately constructed 3-dimensional constellation.

FIG. 3B shows a C1 codebook 320 that represents an example FIVO signal-shaping code. Again, assuming that binary zeros and ones are equiprobable in the input data stream 102, codebook 320 causes the corresponding 4-PAM amplitudes “1” and “3” to have the following respective probabilities in sequence 138:

Pr[1]=0.80;

Pr[3]=0.20.

The average transmit energy per constellation symbol for codebook 320 is 2.6. The average number of amplitudes per information bit is 1.45.

FIG. 3C shows a C1 codebook 330 that represents an example VIVO signal-shaping code. Again, assuming that binary zeros and ones are equiprobable in the input data stream 102, codebook 330 causes the corresponding 4-PAM amplitudes “1” and “3” to have unequal probabilities in sequence 138. In an example embodiment, the average transmit energy per constellation symbol for a VIVO signal-shaping code, such as that of codebook 330, can be even smaller than 2.6 (which is the value of the average transmit energy per constellation symbol for the FIVO codebook 320).

FIG. 4 shows a C2 codebook 400 that can be used in system 100 according to an embodiment. In this particular example, codebook 400 represents a conventional 4-PAM bit-to-amplitude map. In alternative embodiments, other (e.g., longer) FIFO codes can also be used to implement codebook C2. Again, assuming that binary zeros and ones are equiprobable in the input data stream 102, codebook 400 causes the corresponding 4-PAM amplitudes “1” and “3” to have equal probabilities in sequence 138, i.e.:

Pr[1]=Pr[3]=0.5.

The average transmit energy per constellation symbol for codebook 400 is 5. The number of amplitudes per information bit is 1.

Comparing the average transmit energy of each of codebooks 310, 320, and 330 with the average transmit energy of codebook 400, one arrives at the following theoretical values of energy savings: 2.66 dB for codebook 310; 2.84 dB for codebook 320; and greater than about 2.84 dB for codebook 330.

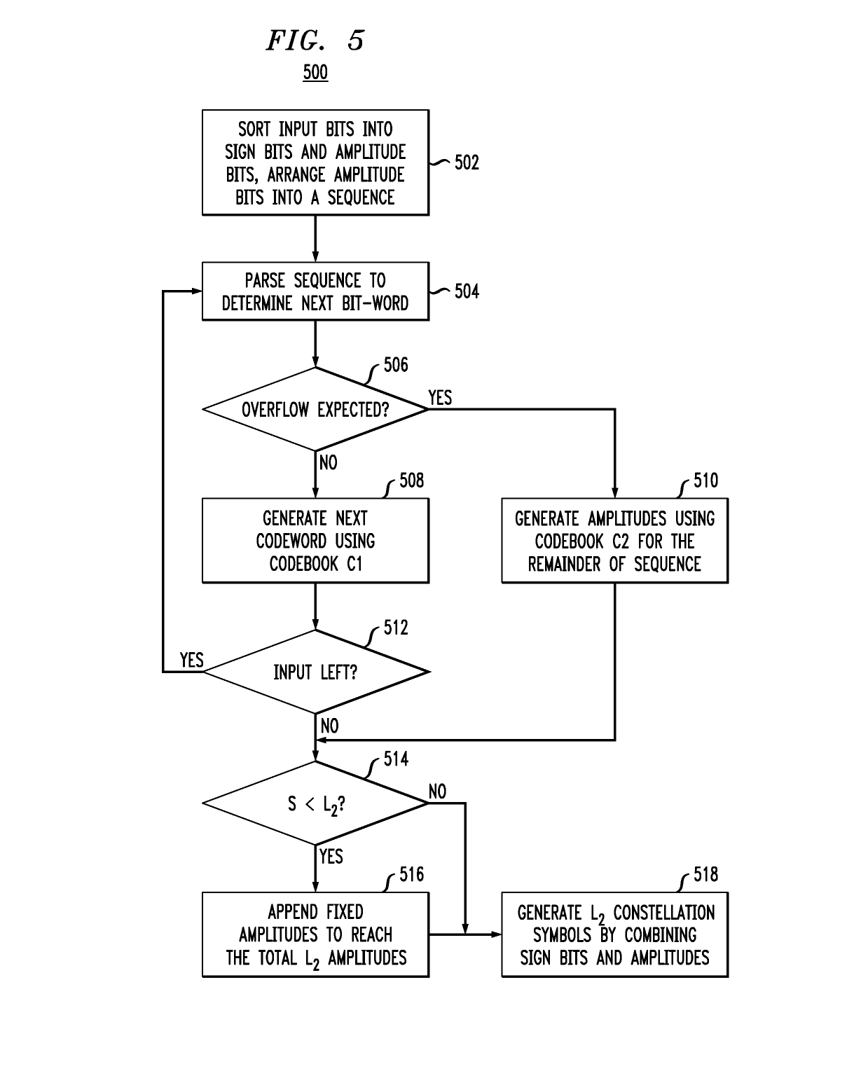

FIG. 5 shows a flowchart of a method 500 of generating sequence 138 that can be used in shaping encoder 110 (FIG. 1) according to an embodiment. More specifically, method 500 can be used to program shaping encoder 110 to convert an input block of L₁ input bits into a set of L₂ 4-PAM constellation symbols.

At step 502 of method 500, shaping encoder 110 receives an input block of K input bits supplied via input data stream 102. The received K input bits are sorted into first and second groups, the first group having L₂ bits that are designated as sign bits, and the second group having L₁ (=K−L₂) bits that are designated as amplitude bits. The sign bits are temporarily stored in a buffer (not explicitly shown in FIG. 1) of constellation mapper 136. The amplitude bits are arranged in a sequence for the subsequent processing performed at steps 504-516.

At step 504, the sequence of amplitude bits is parsed to determine a next bit-word to be encoded. The parsing is performed in accordance with codebook C1 stored in LUT 120₁. To determine the next bit-word, constellation mapper 136 compares several initial bits of the remaining (unprocessed) portion of the sequence of amplitude bits with the bit-words listed in the bit-word column of codebook C1 (see, e.g., FIGS. 3A-3C) until a unique match is found.

At step 506, control circuit 112 checks whether or not an output overflow is expected. The quantitative condition used at step 506 to predict an output overflow depends on the particular embodiment in general, and on the particular codebook C1 stored in LUT 120₁ in particular. Several examples of a quantitative condition that can be used at step 506 to predict an output overflow are provided below.

A first example corresponds to codebook 310 of FIG. 3A. Suppose that L₂=600. Since the code of codebook 310 generates on average one output amplitude per 0.74 (=1/1.35) input amplitude bits, the expected average number of input amplitude bits to generate 600 output amplitudes can be calculated as 600×0.74=444 bits. In other words, if constellation mapper 136 receives 444 input amplitude bits, then the expected (on average) length of the output is 600 amplitudes. Therefore, an output overflow is expected if the sequence of amplitude bits is such that more than 600 amplitudes are expected to be generated from 444 input amplitude bits of the received sequence.

Eq. (1) provides a mathematical expression that is based on the above-described considerations:

$$600 - {\sum }_{i = 1}^{n} {v}_{i} \geq ⌈ \frac{444 - {\sum }_{i = 1}^{n} {u}_{i}}{3} ⌉ \times 3 \qquad ( 1 )$$

where vᵢ is the length of the i-th codeword (in this case v₁=3); uᵢ is the length of the i-th bit-word (in this case uᵢ ε{1, 2, . . . , 6}); and n is an integer that indicates that method 500 is currently processing the n-th bit-word of the received sequence of amplitude bits. Qualitatively, the term on the left-hand side of Eq. (1) represents the number of available output-amplitude positions in the fixed-length output block after encoding of the n-th bit-word is completed. The term on the right-hand side of Eq. (1) represents the required space to encode the (n+1)-th bit-word and all subsequent bit-words using the FIFO codebook C2, after having encoded the n-th bit-word using codebook C1. It can mathematically be proven that, if the condition expressed by Eq. (1) is satisfied for the n-th bit-word, then shaping encoder 110 can proceed to encode the n-th bit-word using codebook C1 without expecting an output overflow.

Eqs. (2)-(4) provide additional examples of mathematical expressions that can be used at step 506 to determine whether or not an output overflow is expected. Eq. (2) corresponds to codebook 310 of FIG. 3A and is a more-generalized form of Eq. (1). Eqs. (3) and (4) correspond to codebook 320 of FIG. 3B and codebook 330 of FIG. 3C, respectively.

$$\begin{matrix}{L}_{2} - n {log}_{2} m \geq ⌈ \frac{{L}_{1} - {s}_{n - 1} - {u}_{n}}{{log}_{2} m} ⌉ \times {log}_{2} m & ( 2 ) \\ {L}_{2} - {t}_{n} \geq {L}_{1} - n {log}_{2} m & ( 3 ) \\ {L}_{2} - {t}_{n} \geq ⌈ \frac{{L}_{1} - {s}_{n - 1} - {u}_{n}}{{log}_{2} m} ⌉ \times {log}_{2} m & ( 4 )\end{matrix}$$

In Eqs. (2)-(4), m is the number of codewords in codebook C1; L₁≈round(βL₂), where β is the information rate of the code represented by codebook C1; sₙ₋₁ is the sum of the lengths of the initial (n−1) bit-words; uₙ is the length of the n-th bit-word; and tₙ is the sum of the lengths of the n codewords.

If the corresponding one of Eqs. (1)-(4) is satisfied, then an output overflow is not expected. In this case, the processing of method 500 is directed to step 508. On the other hand, if the corresponding one of Eqs. (2)-(4) is not satisfied, then an output overflow is expected with the continued use of codebook C1. In this case, the processing of method 500 is directed to step 510.

Based on the above examples of the output-overflow condition, a person of ordinary skill in the art will be able to construct and use an output overflow condition suitable for each specific embodiment. For example, for some embodiments, Eqs. (1)-(4) can be modified such that some of the variables uᵢ and vᵢ are replaced by max(uᵢ) and max(vᵢ), respectively. The definition of tₙ can also be modified accordingly. Another possible modification of Eqs. (1)-(4) is to use a corresponding complementary inequality, in which the “≧” sign is replaced by the “<” sign.

At step 508, the bit-word determined by parsing the input sequence of amplitude bits at step 504 is converted into the corresponding codeword using codebook C1. In the mathematical nomenclature used above in the description of step 506, the bit-word processed at step 508 is the n-th bit-word. The resulting codeword is the n-th codeword.

At step 510, control circuit 112 asserts the previously de-asserted control signal 114, which causes constellation mapper 136 to switch to reading from LUT 120₂, instead of reading from LUT 120₁. As a result, constellation mapper 136 is reconfigured to use codebook C2 instead of codebook C1. Constellation mapper 136 then proceeds to use codebook C2 until the remainder the input sequence of amplitude bits is converted into amplitudes.

At step 512, it is determined whether or not the input sequence of amplitude bits has been processed in its entirety. If all bits of the input sequence of amplitude bits have been processed, then the processing of method 500 is directed to step 514. Otherwise, the processing of method 500 is directed back to step 504.

At step 514, the sum S of the lengths of the generated codewords is compared with L₂. If S is smaller than L₂, then an output underflow has occurred and the processing of method 500 is directed to step 516. Otherwise, the processing of method 500 is directed to step 518.

At step 516, a set of (L₂−S) fixed amplitudes (e.g., all “ones”) is appended to the S previously generated amplitudes to generate a total of L₂ amplitudes.

At step 518, the L₂ sign bits stored in the buffer of constellation mapper 136 at step 502 are combined with the L₂ amplitudes generated in the preceding steps to generate L₂ 4-PAM constellation symbols for sequence 138.

Referring back to FIG. 1, shaping decoder 160 processes constellation-symbol sequence 152 received from FE module 150 to reverse the above-described encoding performed by shaping encoder 110 and to recover data stream 102. More specifically, shaping decoder 160 operates to process constellation-symbol sequence 152 block by block, with each block having L₂ constellation symbols. The processing of one such block yields L₁ bits for output data stream 102′.

In an example embodiment, shaping decoder 160 comprises a control circuit 154, LUTs 164₁ and 164₂, a codebook selector 172, and a constellation demapper 176. LUTs 164₁ and 164₂ contain the same codebooks C1 and C2 as LUTs 120₁ and 120₂, respectively. The state of codebook selector 172 is controlled by a control signal 156 that is similar to the above-described control signal 114. Control circuit 154 generates control signal 156 by analyzing constellation-symbol sequence 152 to determine the locations in the sequence where shaping encoder 110 switched from the use of codebook C1 to the use of codebook C2. Based on this analysis, control circuit 154 operates to appropriately change the state of control signal 156 when the decoding process reaches the determined locations. Demapper 176 operates to: (i) partially demap a block of constellation symbols to generate a corresponding set of sign bits and a corresponding sequence of amplitudes; (ii) parse the sequence of amplitudes into codewords using codebooks C1 and C2 stored in LUTs 164₁ and 164₂; (iii) convert each codeword into a corresponding bit-word using the codebooks; and (iv) appropriately combine the set of sign bits and the bit-words to generate a block of L₁ bits for output data stream 102′.

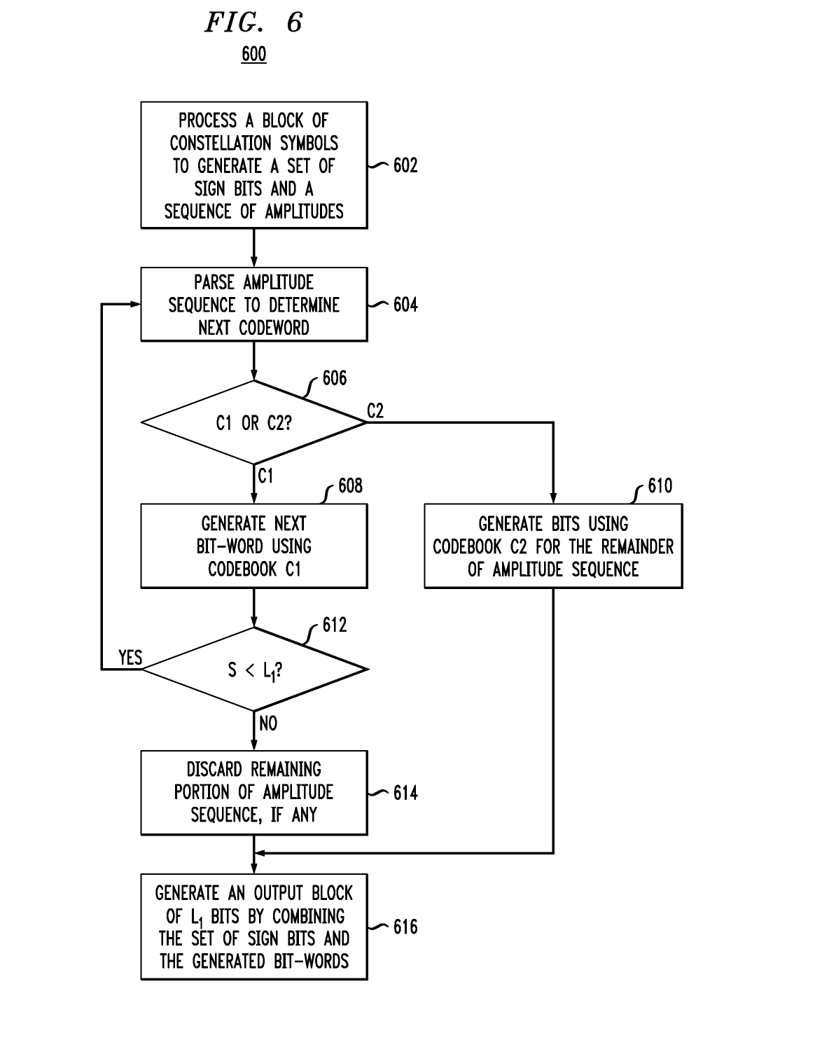

FIG. 6 shows a flowchart of a decoding method 600 that can be used in shaping decoder 160 (FIG. 1) according to an embodiment. Method 600 is designed to work in conjunction with method 500 (FIG. 5). More specifically, method 600 can be used to program shaping decoder 160 to convert an input block of L₂ 4-PAM constellation symbols into a set of L₁ output bits.

At step 602, shaping decoder 160 receives a block of L₂ constellation symbols of constellation-symbol sequence 152. As already indicated above in reference to FIGS. 2A and 2B, each 4-PAM constellation symbol can be represented as a number having a sign and an amplitude. Shaping decoder 160 operates to convert each sign into a corresponding sign bit and temporarily store the sign bits in a buffer (not explicitly shown in FIG. 1) of constellation demapper 176. The amplitudes are arranged in a sequence for the subsequent processing performed at steps 604-616.

At step 604, the sequence of amplitudes is parsed to determine a next codeword to be decoded. The parsing is performed in accordance with codebook C1 stored in LUT 164₁. To determine the next codeword, constellation demapper 176 compares several initial amplitudes of the remaining (unprocessed) portion of the sequence with the codewords listed in the codeword column of codebook C1 (see, e.g., FIGS. 3A-3C) until a unique match is found.

At step 606, control circuit 154 determines whether the codeword was encoded using codebook C1 or codebook C2. This determination can be carried out by checking the same condition as that used at step 504 of the counterpart method 500. Several examples of such condition are already presented and explained above in reference to Eqs. (1)-(4).

If the corresponding one of Eqs. (1)-(4) is satisfied, then the corresponding codeword was generated by shaping encoder 110 using codebook C1. In this case, the processing of method 600 is directed to step 608. On the other hand, if the corresponding one of Eqs. (1)-(4) is not satisfied, then the corresponding codeword was generated by shaping encoder 110 using codebook C2. In this case, the processing of method 600 is directed to step 610.

At step 608, the codeword determined by parsing the sequence of amplitudes at step 604 is converted into the corresponding bit-word using codebook C1. In the mathematical nomenclature, the codeword processed at step 608 is the n-th codeword. The resulting bit-word is the n-th bit-word.

At step 610, control circuit 154 asserts the previously de-asserted control signal 156, which causes constellation demapper 176 to switch to reading from LUT 164₂, instead of reading from LUT 164₁. As a result, constellation demapper 176 is reconfigured to use codebook C2 instead of codebook C1. Constellation demapper 176 then proceeds to use codebook C2 until the remainder the amplitude sequence is converted into bits.

At step 612, the sum S of the lengths of the generated bit-words is compared with L₁. If S is smaller than L₁, then the processing of method 600 is directed back to step 604. Otherwise, the processing of method 600 is directed to step 614.

At step 614, the remaining (unprocessed) portion (if any) of the amplitude sequence is discarded. A person of ordinary skill in the art will understand that the discarded amplitudes do not carry any useful information because they were appended at shaping encoder 110 due to the output underflow.

At step 616, the sign bits stored in the buffer of constellation demapper 176 at step 602 are appropriately combined with the bit-words generated in the preceding steps to generate L₁ bits for output data stream 102′.

FIG. 7 shows a block diagram of a communication system 700 according to an alternative embodiment. System 700 differs from system 100 (FIG. 1) in that it uses FEC coding in addition to signal shaping. However, system 700 still employs many of the same system components as system 100. These system components are labeled in FIG. 7 using the same labels as in FIG. 1, and the description of these system components is not repeated here. Instead, the description of system 700 given below is mostly focused on the differences between the two systems.

Transmitter 104 in system 700 includes a systematic FEC encoder 720 that performs FEC encoding in a conventional manner. More specifically, FEC encoder 720 receives an input bit sequence generated by concatenating a first set of bits 718 and a second set of bits 706 and converts this bit sequence into an expanded bit sequence by appending to the former bit sequence a set of parity bits generated in accordance with the operative FEC algorithm. The parity bits are appended to the second set of bits 706, thereby transforming it into a set of bits 722. Although FEC encoder 720 uses the first set of bits 718 in the process of generating the set of parity bits, the first set of bits 718 passes through FEC encoder 720 without any changes. The first set of bits 718 and the second set of bits 706 are generated from a block of input bits received via input data stream 102 as further detailed below.

A block of K bits of input data stream 102 is applied to a bit sorter 702 that operates to sort the received block into two groups (sets) that are labeled in FIG. 7 using the numerical labels 704 and 706, respectively. The set 704 contains bits that are designated as amplitude bits and, as such, are subjected to encoding processing in a shaping encoder 710. The set 706 contains bits that are designated as sign bits and, as such, are not subjected to encoding processing, and are applied directly to FEC encoder 720. The respective numbers of bits in the sets 704 and 706 depend on the rate of the FEC code used in FEC encoder 720. In general, for the same output length L₂, bit sorter 702 puts fewer bits into the set 706 compared to the number of bits designated as sign bits in constellation mapper 136 (FIG. 1). For example, if FEC encoder 720 generates P parity bits, then the set 706 needs to have only (L₂−P) sign bits. For comparison, constellation mapper 136 designates L₂ bits as sign bits to be able to generate L₂ 4-PAM constellation symbols.

In an example embodiment, shaping encoder 710 performs steps 504-516 of method 500 (FIG. 5) to generate an amplitude set 712 containing L₂ amplitudes. An amplitude-to-bit (A/B) converter 716 operates to convert the amplitude set 712 into the first set of bits 718 to enable FEC encoder 720 to generate the P parity bits in a conventional manner. A bit-to-amplitude (B/A) converter 724 then applies an inverse transformation to regenerate the set 712 using a copy of the set 718 that passes through FEC encoder 720. In an example embodiment, A/B converter 716 and B/A converter 724 can be configured to use the conversion table shown in FIG. 4. In an alternative embodiment (e.g., not using a 4-PAM constellation). A/B converter 716 and B/A converter 724 can be configured to use any other suitable conversion table. A conventional 4-PAM mapper 730 is then used to convert the L₂ amplitudes of the set 712 and the L₂ sign bits of the set into L₂ 4-PAM constellation symbols for sequence 138.

Receiver 108 in system 700 includes a conventional 4-PAM demapper 740 that operates to generate, based on the output signal 152 received from FE module 150, an amplitude set 712′ containing L₂ amplitudes and a sign-bit set of 722′ containing L₂ sign bits. The set 712′ might differ from the set 712 generated at transmitter 104 due to the presence of errors induced by noise 144. The set 722′ might also differ from the set 722 generated at transmitter 104 for the same reason.

A/B converter 716 converts the amplitude set 712′ into bits as described above, thereby generating a set of bits 718′. If the amplitude set 712′ differs from the amplitude set 712, then the set 718′ differs from the set 718 due to error propagation. An FEC decoder 750 operates to correct any errors in the sets 718′ and 722′ using the same FEC code as that used in FEC encoder 720, thereby recovering the sets 718 and 722. FEC decoder 750 then discards the parity bits from the recovered set 722, thereby recovering the sign-bit set 706. B/A converter 724 converts the recovered set 718 into amplitudes as described above, thereby recovering the amplitude set 712. A shaping decoder 760 then decodes the recovered amplitude set 712 to recover the set 704 of amplitude bits. In an example embodiment, shaping decoder 760 can perform the decoding by executing steps 604-614 of method 600.

A bit combiner 770 operates to regenerate the original block of K bits of input data stream 102 by performing an inverse operation to the sorting operation performed by bit sorter 702. Bit combiner 770 then outputs the regenerated block of K bits as part of the output data stream 102′.

Some embodiments of communication systems 100 (FIG. 1) and 700 (FIG. 7) may benefit from the use of signal-shaping codes constructed using the methods and/or concepts described in more detail below in reference to Eqs. (5)-(12) and FIGS. 8-13.

FIG. 8 shows the codeword energy and dyadic approximation of the Maxwell-Boltzmann (M-B) probability obtained using Eqs. (5) and (6) for codebook 310 (FIG. 3A). In general, a C1 codebook can be generated using a geometric Huffman code constructed by dyadic approximation of an M-B distribution. Codeword selection in accordance with an M-B distribution causes a codeword c of energy ∥c∥² to be selected with the probability Pr(c) expressed by Eq. (5):

$$Pr ( c ) = \frac{exp ( - λ {‖ c ‖}^{2} )}{Z ( λ )} \qquad ( 5 )$$

where the parameter λ≧0 determines the information rate and average energy, and Z(λ) is the partition function given by Eq. (6):

$$Z ( λ ) = {\sum }_{c ∈ C 1}^{ } exp ( - λ {‖ c ‖}^{2} ) \qquad ( 6 )$$

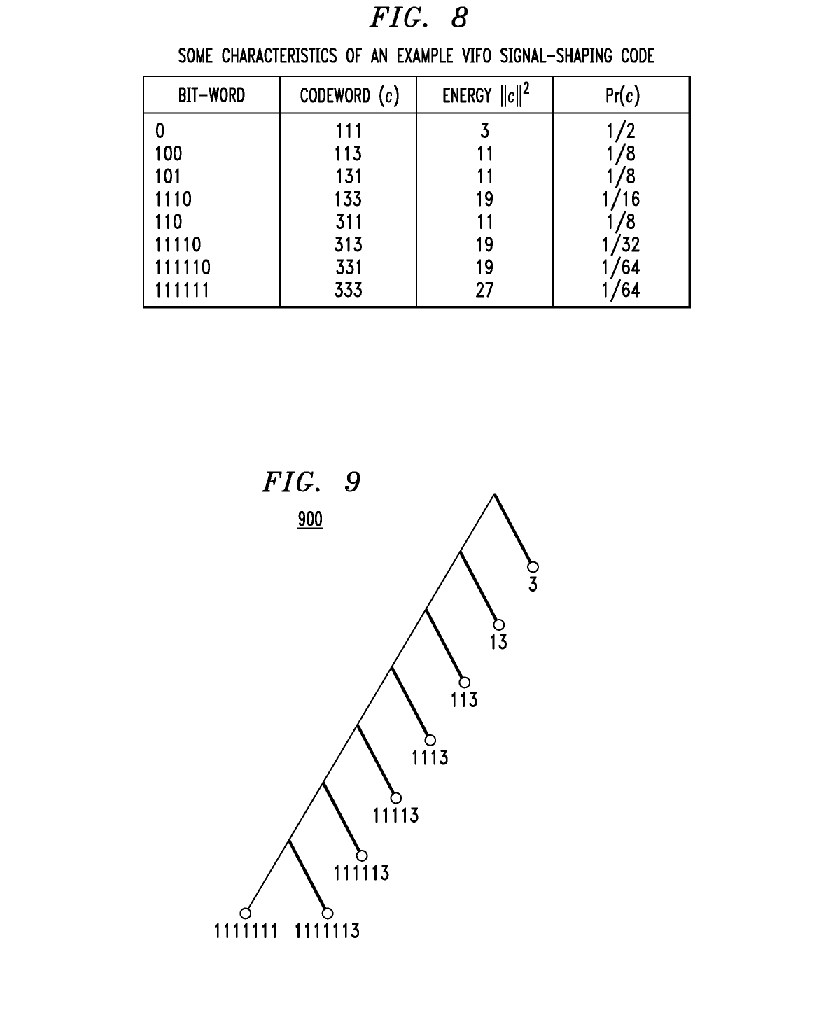

FIG. 9 shows a binary tree 900 that represents codebook 320 (FIG. 3B) according to an embodiment. For purposes of the description that follows, a tree T(m) can be defined as a binary full tree that has m leaf nodes. For example, binary tree 900 is a T(8) tree. The latter can be verified in a straightforward manner by counting the leaf nodes of binary tree 900, which are represented in FIG. 9 by the empty circles. The respective codewords are shown next to the leaf nodes.

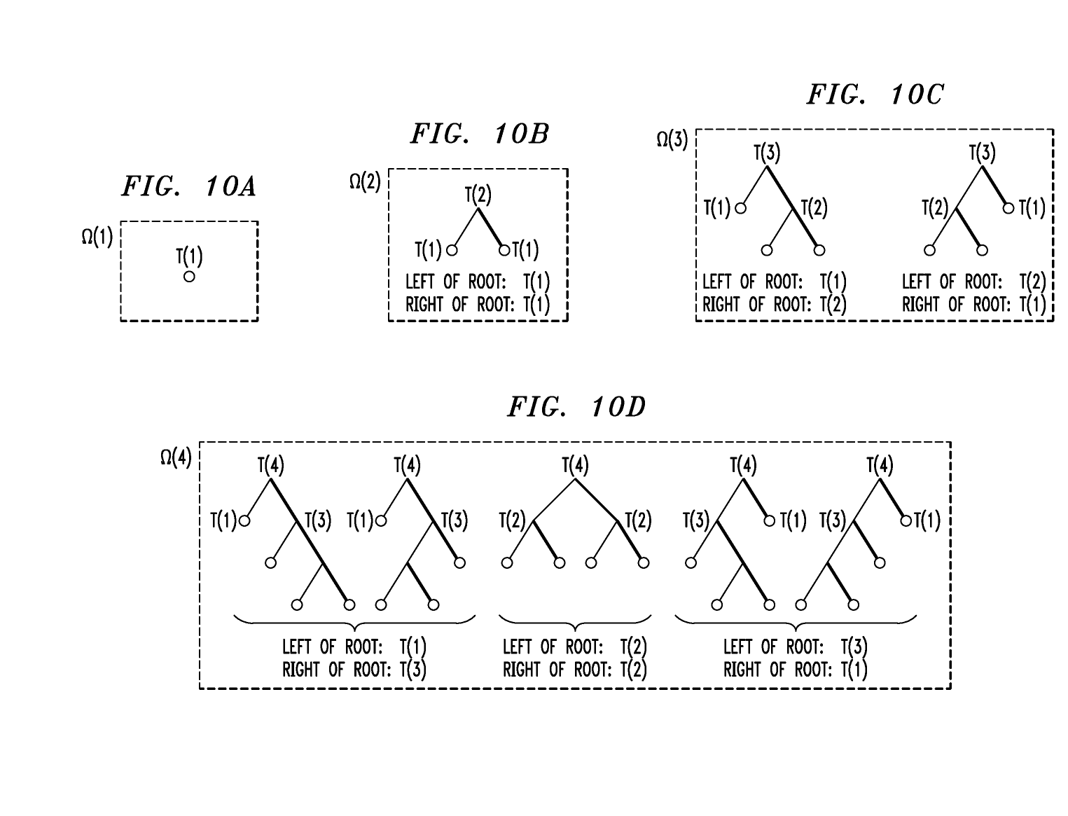

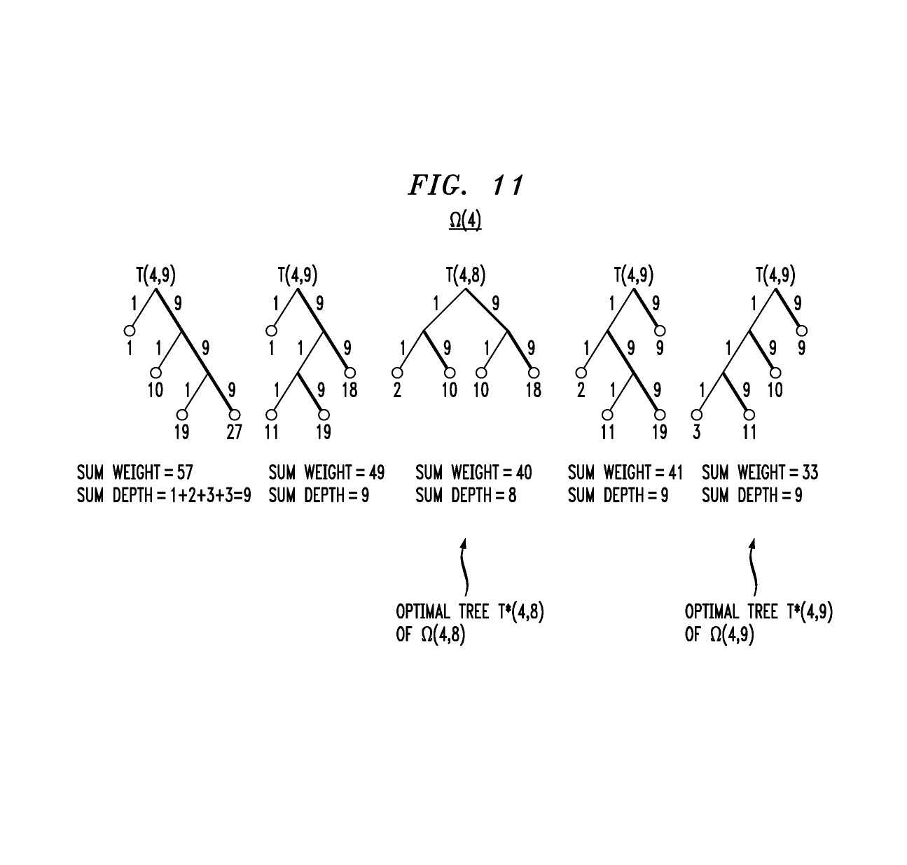

FIGS. 10A-10D show example sets Ω(m) of trees T(m) that can be used to construct a codebook according to an embodiment. Herein, the set Ω(m) is defined as a set of all trees T(m). For example, FIG. 10A shows the set Ω(1), which has a single tree T(1). The tree T(1) is a trivial tree having a single leaf node. FIG. 10B shows the set Ω(2), which has a single tree T(2). FIG. 10C shows the set Ω(3), which has two trees T(3). FIG. 10C shows the set Ω(4), which has five trees T(4).

For example, to enumerate all of the trees T(2)εΩ(2), one can begin with a root node, and then append a tree T(1)εΩ(1) to the left edge of the root node and another tree T(1)εΩ(1) to the right edge of the root node, as depicted in FIG. 10B. In general, assuming that the code developer has already generated all trees of up to (m−1) leaf nodes, she can enumerate all trees T(m)εΩ(m) by appending a tree T(i)εΩ(i) to the left edge of the root node, and another tree T(m−i)εΩ(m−i) to the right edge of the root node, for each i=1, 2, . . . , m−1. Example steps of this recursive process are illustrated by FIGS. 10C and 10D. A person of ordinary skill in the art will understand how to continue the illustrated recursive process to enumerate all of trees T(k)εΩ(k), where k=5, 6, 7, and so on.

From a graph theory perspective, the above-described trees T(m) belong to a class of rooted ordered full binary trees. The number of such trees in the corresponding set Ω(m). i.e., the cardinality of Ω(m), equals the Catalan number Cₘ₋₁, as expressed by Eq. (7):

$$\vert Ω ( m ) \vert = {C}_{m - 1} = \frac{( 2 ( m - 1 ) ) !}{m ! ( m - 1 ) !} \qquad ( 7 )$$

Suppose now that every left edge has the weight of 1, and every right edge has the weight of 9, which correspond to the transmit energies of the amplitudes 1 and 3, respectively, of a PAM-4 constellation. One can then define the following quantities.

The weight of a leaf node is defined by the sum of the edge weights along the path from the root node to the leaf node.

The sum weight of a tree is defined by the sum of the weights of all leaf nodes.

The depth of a leaf node is defined by the number of the edges on the path from the root node to the leaf node.

The sum depth of a tree is defined by the sum of the depths of all leaf nodes.

A tree T(m, n) is a binary full tree of m leaf nodes, whose sum depth is n. For example, the tree 900 (FIG. 9) is a T(8, 24) tree.

It can then be verified in a relatively straightforward manner that that the following statements are true:
1. a tree represents a codebook;
2. a leaf node of the tree corresponds to a codeword in the codebook;
3. the number of the leaf nodes, m, is the number of codewords in the codebook;
4. the depth of a leaf node is the length of the codeword;
5. the sum depth of a tree, n, is the number of all (amplitude) symbols in the codebook;
6. the weight of a leaf node is the energy needed to transmit the corresponding codeword;
7. the sum weight of a tree divided by the sum depth is the average symbol energy of the corresponding codebook.

FIG. 11 shows the set Ω(4) of FIG. 10D with added annotations showing the edge weights, leaf-node weights, sum weights, and sum depths of the trees T(4, n) therein. The set Ω(4) has two subsets: (i) the subset Ω(4, 9) that has four trees T(4, 9) and (ii) the subset Ω(4, 8) that has the single tree T(4, 8). It should also be noted here that, in general, all trees T(m, n) in the subset Ω(m, n) are characterized by the same information rate β.

As used herein the term “optimal tree” refers to a tree T*(m, n) that has a minimum sum weight among all trees in the corresponding subset Ω(m, n).

For example, as indicated in FIG. 11, the optimal trees of the subsets Ω(4, 8) and Ω(4, 9) of the set Ω(4) have the sum weights of 40 and 33, respectively. The average symbol energies for these optimal trees are 40/8=5 and 33/93.667, respectively. The optimal tree T*(4, 8) of FIG. 11 can also be referred to as the perfectly balanced tree because all leaf nodes thereof have the same depth of 2 (=log₂ m). This particular optimal tree represents the codebook T(4, 8) that implements the unshaped uniform signal transmission in accordance with the FIFO code 400 (FIG. 4).

The information rate of the tree T*(4, 8) of FIG. 11 is 1. For comparison, the information rate of the tree T*(4, 9) of FIG. 11 is 8/9.

As used herein, the term “optimal codebook” refers to a codebook that is represented by an optimal tree of the corresponding subset Ω(m, n). From the above-provided description, a person of ordinary skill in the art will understand that an optimal codebook enables the corresponding communication system to achieve a given information rate β with a minimum average symbol-transmit energy.

In one example embodiment, an optimal tree T*(m, n) (and hence the corresponding optimal codebook) can be found for each pair of m and n using an exhaustive search. Such an exhaustive search can be conducted in a recursive manner starting from the pair (m, n)=(1,1) and continuing on by (i) incrementally increasing the value of m; (ii) inspecting the properties of all trees T(m, n) in the corresponding subsets Ω(m, n); and (iii) identifying the optimal tree of each subset Ω(m, n) based on the results of the inspection. This search method works well for relatively small values of m. However, for relatively large values of m, the search space of the exhaustive search may become too large for the computational power available to the code developer, e.g., because the search space grows substantially exponentially with the increase of m (see, e.g., Eq. (7)). In such situations, it might be advisable for the code developer to use an alternative method of finding an optimal tree T*(m, n) and the corresponding optimal codebook, which alternative method is described in more detail below in reference to Eqs. (8)-(12). A beneficial feature of the latter method is that it can reduce the search space to a manageable volume, thereby enabling the code developer to construct optimal codebooks corresponding to larger values of m than would have been technically feasible with the same computational power using the exhaustive search.

In general, a mathematical problem is said to have an optimal substructure if a solution to the problem can be constructed efficiently from the solutions of its sub-problems. It can be shown, e.g., as indicated below, that the problem of finding optimal trees T*(m, n) and constructing the corresponding optimal codebooks has an optimal substructure.

Suppose that the optimal tree T*(m, n) has a sub-tree T(i, j), where i<m and j<n, on either side of the root. If the sub-tree T(i, j) is not an optimal tree, then there exists a sub-tree T*(i, j) that has a smaller sum weight than that of T(i, j), in which case one can construct a tree T(m, n) that has a smaller sum weight than that of T*(m, n) by replacing the sub-tree T(i, j) by the sub-tree T*(i, j) in T*(m, n). The latter result contradicts the initial assumption of the tree T*(m, n) being an optimal tree. It therefore follows that an optimal tree T*(m, n) is composed of optimal sub-trees T*(i, j). The latter property is a manifestation of the optimal substructure for the aforementioned problem of finding optimal trees T*(m, n) and constructing the corresponding optimal codebooks.

It can be verified in a relatively straightforward manner that the number of symbols in the codebooks of size m (assuming that m is an integer power of 2) is bounded by the following inequality:

$$m {log}_{2} m \leq n \leq \frac{m ( m + 1 )}{2} \qquad ( 8 )$$

The left equality of Eq. (8) holds for unshaped uniform signaling, and the right equality of Eq. (8) corresponds to the case of relatively extreme signal shaping, wherein only the left (or the right) edge from the root is chosen in the process of tree expansion until all m leaves of the tree are obtained, e.g., as shown in FIG. 9. When m is not an integer power of 2, Eq. (8) can be replaced by Eq. (9):

$$m ⌊ {log}_{2} m ⌋ \leq n \leq \frac{m ( m + 1 )}{2} - 1 \qquad ( 9 )$$

Due to the above-described properties of optimal sub-trees, it is sufficient to construct one optimal tree for each pair of m and n. It follows from Eqs. (8)-(9) that, for a given m, the number of all optimal trees that need to be constructed is the same as the number of distinct integers for that m, which can be calculated using Eq. (10) as follows:

$$\vert {Ω}^{*} ( m ) \vert \leq {a}_{m} = \frac{m ( m + 1 )}{2} - m ⌊ {log}_{2} m ⌋ \qquad ( 10 )$$

When constructing a tree T(m), the code developer can attach T*(i) as the left child and T*(m−i) as the right child of the root node, for every 1≦i≦m−1. Under this method of construction, the size of the search space Ψₘ, from which to select the optimal trees T*(m, n) for the given value of m, can be calculated using Eq. (11) as follows:

$$\vert {Ψ}_{m} \vert \leq {\sum }_{i}^{m - 1} {a}_{i} {a}_{m - i} \qquad ( 11 )$$

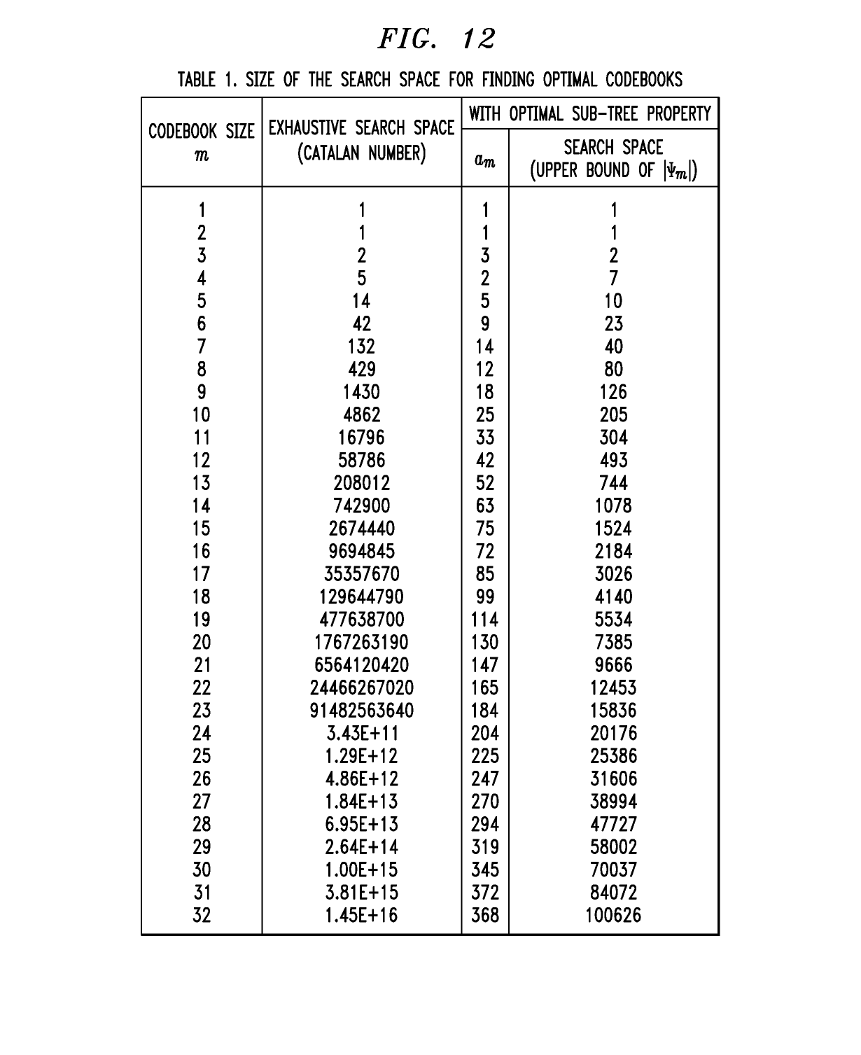

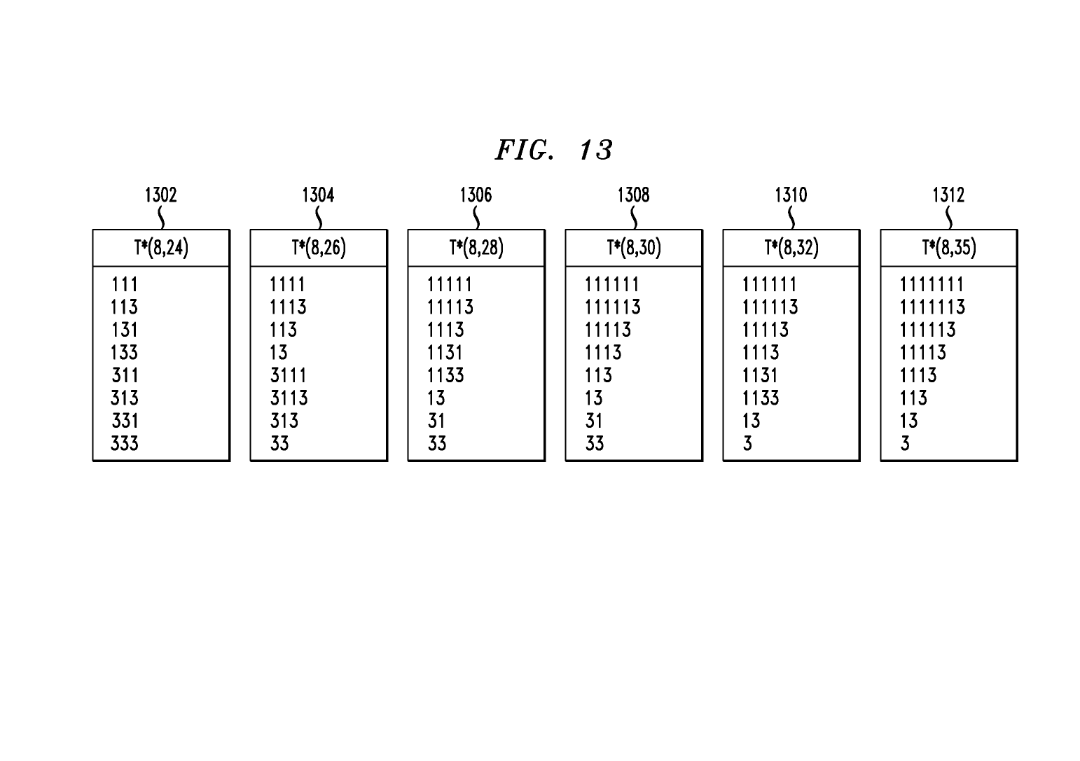

FIG. 12 shows a table that illustrates the reduction of the search space that can be achieved using the above-described alternative method of finding an optimal tree T*(m, n) instead of using the exhaustive search. It can be seen from the data of FIG. 12 that a space reduction on the scale of many orders of magnitude is possible for relatively large values of m.

In some embodiments, further reduction of the search space Ψₘ can be achieved by exploiting the fact that an unbalanced optimal tree has more leaf nodes on the left edge than on the right edge of the root (see, e.g., FIG. 11). In such embodiments, the size of the search space Ψₘ can be upper-bounded by Eq. (12) as follows:

$$\vert {Ψ}_{m} \vert \leq {\sum }_{i = ⌈ \frac{m}{2} ⌉}^{m - 1} {a}_{i} {a}_{m - i} \qquad ( 12 )$$

As already indicated above, the reduction of the search space advantageously enables the code developer to efficiently construct a signal-shaping codebook having a relatively large number m of codewords therein. Having such codebooks available for use in the corresponding communication system typically enables the resulting distribution of transmitted constellation symbols to better approximate the M-B distribution and, as such, achieve a higher shaping gain.

FIG. 13 shows example sets 1302-1312 of codewords corresponding to m=8 that have been constructed according to an embodiment. More specifically, each of the sets 1302-1312 has been constructed based on the corresponding optimal tree T*(8, n) found using the above-described search methods. For example, the set 1302 corresponds to codebook 310 of FIG. 3A. The set 1312 corresponds to codebook 320 of FIG. 3B and codebook 330 of FIG. 3C.

According to an example embodiment disclosed above in reference to FIGS. 1-13, provided is an apparatus comprising: a shaping encoder (e.g., 110, FIG. 1; 710, FIG. 7) configured to use a variable-length shaping code (e.g., one of 310-330, FIG. 3) to convert an input block of bits (e.g., received via 102, FIGS. 1, 7) into an output sequence of constellation symbols (e.g., part of 138, FIGS. 1, 7), the input block of bits having a first fixed number (e.g., K) of bits, and the output sequence of constellation symbols having a second fixed number (e.g., L₂) of constellation symbols; and a transmitter (e.g., 140, FIGS. 1, 7) operatively coupled to the shaping encoder to transmit a modulated signal (e.g., 142, FIGS. 1, 7) carrying the output sequence of constellation symbols.

In some embodiments of the above apparatus, the shaping encoder is configured to generate the output sequence of constellation symbols using a PAM constellation (e.g., one or both of 210 and 220, FIG. 2).

In some embodiments of any of the above apparatus, the first fixed number and the second fixed number are constants that do not depend on a bit sequence of the input block of bits.

In some embodiments of any of the above apparatus, the variable-length shaping code causes a rate of occurrence of different constellation symbols in the output sequence of constellation symbols to depend on a symbol transmit energy (e.g., as described in reference to FIGS. 3A-3C).

In some embodiments of any of the above apparatus, the variable-length shaping code causes a distribution of the constellation symbols over the symbol transmit energy to approximate a Gaussian distribution.

In some embodiments of any of the above apparatus, the variable-length shaping code is a VIFO code (e.g., 310, FIG. 3A), a FIVO code (e.g., 320, FIG. 3B), or a VIVO code (e.g., 330, FIG. 3C).

In some embodiments of any of the above apparatus, the shaping encoder comprises a code-selector circuit (e.g., 112/132, FIGS. 1, 7) capable of switching the shaping encoder from using the variable-length shaping code to using a FIFO code (e.g., 400, FIG. 4) during a process of converting the input block of bits into the output sequence of constellation symbols.

In some embodiments of any of the above apparatus, the code-selector circuit is configured to: check an output-overflow condition (e.g., expressed by one of Eqs. (1)-(4)) for each bit-word to be encoded using the variable-length shaping code; and switch the shaping encoder from using the variable-length shaping code to using the FIFO code if the output-overflow condition is satisfied.

In some embodiments of any of the above apparatus, the output-overflow condition is satisfied if a continued use of the variable-length shaping code is expected to cause the output sequence of constellation symbols to have more constellation symbols than the second fixed number.

In some embodiments of any of the above apparatus, the apparatus further comprises an FEC encoder (e.g., 720, FIG. 7) operatively connected to the shaping encoder and configured to cause the output sequence of constellation symbols to have encoded thereon a set of parity bits corresponding to the input block of bits.

In some embodiments of any of the above apparatus, the apparatus further comprises a sorter circuit (e.g., 702, FIG. 7) configured to sort the input block of bits into a first set (e.g., 704, FIG. 7) and a second set (e.g., 706, FIG. 7); and wherein the shaping encoder is configured to apply the variable-length shaping code to the first set, but not to the second set (e.g., as indicated in FIG. 7).

In some embodiments of any of the above apparatus, the FEC encoder is configured to convert the second set into a third set of bits by appending the set of parity bits to the second set; wherein the shaping encoder is further configured to: apply the variable-length shaping code to the first set to generate a set of amplitudes; and generate the output sequence of constellation symbols in a manner that causes each constellation symbol to have (i) a respective amplitude from the set of amplitudes and (ii) a phase defined by a respective subset of bits from the third set of bits.

In some embodiments of any of the above apparatus, each respective subset has a single respective bit (e.g., if a PAM constellation, such as 210 or 220 of FIG. 2, is used).

In some embodiments of any of the above apparatus, each respective subset has a respective pair of bits (e.g., if a QAM constellation, such as 230 of FIG. 2, is used).

In some embodiments of any of the above apparatus, the apparatus further comprises: a receiver (e.g., 150, FIGS. 1, 7) coupled to the transmitter to receive the modulated signal and to generate therefrom a corresponding sequence of constellation symbols (e.g., 152, FIGS. 1, 7); and a shaping decoder (e.g., 160, FIG. 1; 760, FIG. 7) configured to use the variable-length shaping code to recover the input block of bits from said corresponding sequence of constellation symbols.

In some embodiments of any of the above apparatus, the transmitter comprises an optical transmitter; and the receiver comprises a coherent optical receiver that is optically coupled to the optical transmitter by way of an optical fiber or fiber-optic cable (e.g., 106, FIGS. 1, 7).

According to another example embodiment disclosed above in reference to FIGS. 1-13, provided is a machine-implemented communication method comprising the steps of: receiving (e.g., via 102, FIGS. 1, 7) an input block of bits having a first fixed number (e.g., K) of bits; and converting the input block of bits into an output sequence of constellation symbols (e.g., part of 138, FIGS. 1, 7) having a second fixed number (e.g., L₂) of constellation symbols, said converting being performed using a shaping encoder (e.g., 110, FIG. 1; 710, FIG. 7) configured to use a variable-length shaping code (e.g., one of 310-330, FIG. 3).

In some embodiments of the above method, the method further comprises generating a modulated optical signal (e.g., 142, FIGS. 1, 7) to carry the output sequence of constellation symbols over an optical fiber or fiber-optic cable (e.g., 106, FIGS. 1, 7).

In some embodiments of any of the above methods, said converting comprises: checking (e.g., 506, FIG. 5) an output-overflow condition (e.g., expressed by one of inequalities (1)-(4) or by one of complementary inequalities) for each bit-word to be encoded using the variable-length shaping code; and switching (e.g., 508/510, FIG. 5) the shaping encoder from using the variable-length shaping code to using a FIFO code (e.g., 400, FIG. 4) if the output-overflow condition is satisfied.

In some embodiments of any of the above methods, the first fixed number and the second fixed number are constants that do not depend on a bit sequence of the input block of bits.

In some embodiments of any of the above methods, the variable-length shaping code causes a rate of occurrence of different constellation symbols in the output sequence of constellation symbols to depend on a symbol transmit energy (e.g., as described in reference to FIGS. 3A-3C).

In some embodiments of any of the above methods, the variable-length shaping code causes a distribution of the constellation symbols over the symbol transmit energy to approximate a Gaussian distribution.

In some embodiments of any of the above methods, the variable-length shaping code is a VIFO code (e.g., 310, FIG. 3A), a FIVO code (e.g., 320, FIG. 3B), or a VIVO code (e.g., 330, FIG. 3C).

According to yet another example embodiment disclosed above in reference to FIGS. 1-13, provided is a communication method comprising the steps of: configuring a shaping encoder (e.g., 110, FIG. 1; 710, FIG. 7) to use a variable-length shaping code (e.g., one of 310-330, FIG. 3) to convert an input block of bits (e.g., received via 102, FIGS. 1, 7) into an output sequence of constellation symbols (e.g., part of 138, FIGS. 1, 7), the input block of bits having a first fixed number (e.g., K) of bits, and the output sequence of constellation symbols having a second fixed number (e.g., L₂) of constellation symbols; and operatively coupling a transmitter (e.g., 140, FIGS. 1, 7) to the shaping encoder, the transmitter being capable of transmitting a modulated signal (e.g., 142, FIGS. 1, 7) carrying the output sequence of constellation symbols.

While this disclosure includes references to illustrative embodiments, this specification is not intended to be construed in a limiting sense.

Although representative embodiments of transmitter 104 and receiver 108 are described above in reference to the general device architectures shown in FIGS. 1 and 7, the invention(s) disclosed herein are not so limited. Based on the provided description, a person of ordinary skill in the art will be able to construct alternative device architectures without any undue experimentation. For example, an alternative embodiment of transmitter 104 mat use two constellation mappers, the first of which performs C1-based mapping and the second of which performs C2-based mapping. A control circuit that is functionally similar to control circuit 112 can then be used to cause the transmitter to switch between the two constellation mappers to enable each output block of constellation symbols to have a fixed length, thereby enabling FIFO encoding with the use of a variable-length signal shaping code. An alternative embodiment of receiver 108 can similarly be constructed.

Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

As used herein, the terms “assert” and “de-assert” are used when referring to the rendering of a control signal, status bit, or other relevant functional feature or element into its logically true and logically false state, respectively. If the logically true state is a logic level one, then the logically false state is a logic level zero. Alternatively, if the logically true state is logic level zero, then the logically false state is logic level one.

In various alternative embodiments, each logic signal described herein may be generated using positive or negative logic circuitry. For example, in the case of a negative logic signal, the signal is active low, and the logically true state corresponds to a logic level zero. Alternatively, in the case of a positive logic signal, the signal is active high, and the logically true state corresponds to a logic level one.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The description and drawings merely illustrate the principles of the disclosure. It will thus be appreciated that those of ordinary skill in the art will be able to devise various arrangements that, although not explicitly described or shown herein, embody the principles of the disclosure and are included within its spirit and scope. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

The functions of the various elements shown in the figures, including any functional blocks labeled as “processors” and/or “controllers,” may be provided through the use of dedicated hardware as well as hardware capable of executing software in association with appropriate software. Some circuit elements may be implemented using, without limitation, digital signal processor (DSP) hardware, an application specific integrated circuit (ASIC), a field programmable gate array (FPGA), a read only memory (ROM) for storing software, a random access memory (RAM), and non-volatile storage. Other hardware, conventional and/or custom, may also be included.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus comprising:
a shaping encoder configured to use a variable-length shaping code to convert an input block of bits into an output sequence of constellation symbols, the input block of bits having a first fixed number of bits, and the output sequence of constellation symbols having a second fixed number of constellation symbols; and
a transmitter operatively coupled to the shaping encoder to transmit a modulated signal carrying the output sequence of constellation symbols.

2. The apparatus of claim 1, wherein the shaping encoder is configured to generate the output sequence of constellation symbols using a PAM constellation.

3. The apparatus of claim 1, wherein the first fixed number and the second fixed number are constants that do not depend on a bit sequence of the input block of bits.

4. The apparatus of claim 1, wherein the variable-length shaping code causes a rate of occurrence of different constellation symbols in the output sequence of constellation symbols to depend on a symbol transmit energy.

5. The apparatus of claim 4, wherein the variable-length shaping code causes a distribution of the constellation symbols over the symbol transmit energy to approximate a Gaussian distribution.

6. The apparatus of claim 1, wherein the variable-length shaping code is a VIFO code, a FIVO code, or a VIVO code.

7. The apparatus of claim 1, wherein the shaping encoder comprises a code-selector circuit capable of switching the shaping encoder from using the variable-length shaping code to using a FIFO code during a process of converting the input block of bits into the output sequence of constellation symbols.

8. The apparatus of claim 7, wherein the code-selector circuit is configured to:
check an output-overflow condition for each bit-word to be encoded using the variable-length shaping code; and
switch the shaping encoder from using the variable-length shaping code to using the FIFO code if the output-overflow condition is satisfied.

9. The apparatus of claim 8, wherein the output-overflow condition is satisfied if a continued use of the variable-length shaping code is expected to cause the output sequence of constellation symbols to have more constellation symbols than the second fixed number.

10. The apparatus of claim 1, further comprising an FEC encoder operatively connected to the shaping encoder and configured to cause the output sequence of constellation symbols to have encoded thereon a set of parity bits corresponding to the input block of bits.

11. The apparatus of claim 10, further comprising a sorter circuit configured to sort the input block of bits into a first set and a second set; and
wherein the shaping encoder is configured to apply the variable-length shaping code to the first set, but not to the second set.

12. The apparatus of claim 11,
wherein the FEC encoder is configured to convert the second set into a third set of bits by appending the set of parity bits to the second set;
wherein the shaping encoder is further configured to:
apply the variable-length shaping code to the first set to generate a set of amplitudes; and
generate the output sequence of constellation symbols in a manner that causes each constellation symbol to have (i) a respective amplitude from the set of amplitudes and (ii) a phase defined by a respective subset of bits from the third set of bits.

13. The apparatus of claim 12, wherein each respective subset has a single respective bit.

14. The apparatus of claim 12, wherein each respective subset has a respective pair of bits.

15. The apparatus of claim 1, further comprising:
a receiver coupled to the transmitter to receive the modulated signal and to generate therefrom a corresponding sequence of constellation symbols; and
a shaping decoder configured to use the variable-length shaping code to recover the input block of bits from said corresponding sequence of constellation symbols.

16. A machine-implemented communication method comprising:
receiving an input block of bits having a first fixed number of bits; and
converting the input block of bits into an output sequence of constellation symbols having a second fixed number of constellation symbols, said converting being performed using a shaping encoder configured to use a variable-length shaping code.

17. The machine-implemented communication method of claim 16, further comprising generating a modulated optical signal to carry the output sequence of constellation symbols over an optical fiber or fiber-optic cable.

18. The machine-implemented communication method of claim 16, wherein said converting comprises:
checking an output-overflow condition for each bit-word to be encoded using the variable-length shaping code; and
switching the shaping encoder from using the variable-length shaping code to using a FIFO code if the output-overflow condition is satisfied.

19. The machine-implemented communication method of claim 16, wherein the variable-length shaping code causes a rate of occurrence of different constellation symbols in the output sequence of constellation symbols to depend on a symbol transmit energy.

20. A communication method comprising:
configuring a shaping encoder to use a variable-length shaping code to convert an input block of bits into an output sequence of constellation symbols, the input block of bits having a first fixed number of bits, and the output sequence of constellation symbols having a second fixed number of constellation symbols; and
operatively coupling a transmitter to the shaping encoder, the transmitter being capable of transmitting a modulated signal carrying the output sequence of constellation symbols.
